(19) United States
(12) Patent Application Publication
(10) Pub. No.: US 2025/0220436 A1
(43) Pub. Date: Jul. 3, 2025

(54) INFORMATION PROCESSING APPARATUS AND COMMUNICATION SYSTEM

(71) Applicant: TOYOTA JIDOSHA KABUSHIKI KAISHA, Toyota-shi (JP)

(72) Inventors: Hiroshi ABE, Kasukabe-shi (JP); Koji TAKEOKA, Yokohama-shi (JP); Kiichi IWASAKI, Nagoya-shi (JP); Takayuki SAKAI, Setagaya-ku (JP); Isao NISHIOKA, Nagoya-shi (JP); Yasuhiro KOBATAKE, Nagoya-shi (JP)

(73) Assignee: TOYOTA JIDOSHA KABUSHIKI KAISHA, Toyota-shi (JP)

(21) Appl. No.: 18/991,807

(22) Filed: Dec. 23, 2024

(30) Foreign Application Priority Data
Dec. 28, 2023 (JP) 2023-222258

(51) Int. Cl. H04W 12/48; H04W 12/06

(52) U.S. Cl. CPC H04W 12/48; H04W 12/06

(57) ABSTRACT

An information processing apparatus is arranged within a communication system that comprises a storage that stores authentication data for authenticating mobile communication terminals and a gateway that accommodates access from a first communication network. The communication system authenticates a mobile communication terminal connected via the first communication network and the gateway, using the authentication data. The information processing apparatus comprises a controller that relays communications from the mobile communication terminal to one or more security apparatuses based on information related to the authentication.

### CROSS REFERENCE TO THE RELATED APPLICATION

This application claims the benefit of Japanese Patent Application No. 2023-222258, filed on Dec. 28, 2023, which is hereby incorporated by reference herein in its entirety.

### BACKGROUND

### Technical Field

The present disclosure relates to communications technology.

### Description of the Related Art

There is a technique for dynamically selecting a communication method to be used by a mobile unit.

In this regard, for example, Japanese Patent Application Laid-Open Publication No. 2016-025505 discloses an in-vehicle terminal device that switches between short-range communication and wide-range communication depending on the type of data to be transmitted and received.

### SUMMARY

The present disclosure aims to improve security in communications.

The present disclosure in its one aspect provides an information processing apparatus that is arranged within a communication system that comprises a storage that stores authentication data for authenticating mobile communication terminals and a gateway that accommodates access from a first communication network, and authenticates a mobile communication terminal connected via the first communication network and the gateway, using the authentication data, the information processing apparatus comprising a controller that relays communications from the mobile communication terminal to one or more security apparatuses based on information related to the authentication.

The present disclosure in its another aspect provides a communication system comprising: a storage that stores authentication data for authenticating mobile communication terminals, a gateway that accommodates access from a first communication network, and a controller configured to perform: authenticating a mobile communication terminal connected via the first communication network and the gateway, using the authentication data; and relaying communications from the mobile communication terminal to one or more security apparatuses based on information related to the authentication.

Further, another aspect includes a program for causing a computer to execute the method executed by the above-mentioned device or system, or a computer-readable storage medium non-transitory storing the program.

According to the present disclosure, security in communications can be improved.

### BRIEF DESCRIPTION OF THE DRAWINGS

FIG. 1 is a schematic diagram of a vehicle communication network according to an embodiment.

FIG. 2 is a diagram showing in more detail the network configuration shown in FIG.

FIG. 3 is a schematic diagram showing the configuration of the DCM 10 and the communication device 11. As shown in FIG.

FIG. 4 is a schematic diagram showing the configuration of the authentication device 20. As shown in FIG.

FIG. 5 is an example of security setting data.

FIG. 6 is a flowchart of the process executed by the authentication device 20.

### DESCRIPTION OF THE EMBODIMENTS

In recent years, automobiles have become increasingly connected, and an increasing number of vehicles are equipped with on-board devices that have wireless communication capabilities. The in-vehicle device can provide various services to the vehicle occupants by communicating with a server apparatus (such as an application server) via a cellular communication network, for example.

The server apparatus with which the vehicle-mounted device communicates is not necessarily located on a network where security is ensured. Therefore, it is preferable that the in-vehicle device executes security-related services (e.g, antivirus services, etc.).

It is expected that as the amount of processing performed by in-vehicle devices increases in the future, more resources will be consumed for security processing. However, unlike general-purpose computers, the processors of in-vehicle devices often have limited resources available, making it difficult to allocate a large number of resources to security. The communication system according to the present disclosure solves such problems.

An information processing apparatus according to a first aspect of the present disclosure is an information processing apparatus has a storage that stores authentication data for authenticating mobile communication terminals, and a gateway that accommodates access from a first communication network, and is arranged within a communication system that authenticates a mobile communication terminal connected via the first communication network and the gateway using the authentication data, and has a controller that relays communications from the mobile communication terminal to one or more security apparatuses based on information related to the authentication.

The mobile communication terminal is typically an in-vehicle terminal mounted in a vehicle, but is not limited to this.

A gateway is a terminating device in a communication system that accommodates access via a first communication network. The first communication network may be an insecure network, for example an IP communication network.

The information processing apparatus is arranged within a communication system having a storage that stores authentication data, and a gateway. Within the communication system, a device for authenticating mobile communication terminals may be arranged independently of the information processing apparatus device, or the information processing apparatus may also function as a device for authenticating mobile communication terminals. The communication system authenticates a mobile communication terminal connected via a first communication network and a gateway.

The controller relays communications from the mobile communication terminal to one or more security apparatuses based on information regarding the authentication.

The one or more security apparatuses are typically located outside the communication system and are devices that provide anti-virus services, anti-malware services, sandbox services, and the like.

When a mobile communication terminal is connected to a communication system via a non-secure path, it is preferable for the communication path to be via a device that provides security services somewhere along the communication path. The controller then relays communications from the mobile communication terminal to one or more security apparatuses based on information regarding the authentication. The information regarding the authentication may include an identifier of the mobile communication terminal.

For example, when the gateway accommodates access from a first communication network that is not secure, it is preferable to provide security-related services to a mobile communication terminal that accesses via the gateway.

In addition, the controller may acquire binding data that associates the mobile communication terminal with a security apparatus to which communications from the mobile communication terminal will be relayed, and determine the security apparatus that will relay communications from the mobile communication terminal based on the binding data.

According to this configuration, it is possible to determine for each mobile communication terminal which of the multiple security apparatuses to forward communication to.

Furthermore, the controller may relay communication from the mobile communication terminal to the one or more security apparatuses when the destination of the communication from the mobile communication terminal is not a device within the communication system.

There are cases where the destination of a communication from a mobile communication terminal is not a device within the communication system. For example, there are cases where a communication system is connected to the Internet via a packet gateway (PGW) or the like. Since the Internet is generally not a secure network, when a communication destination from a mobile communication terminal is the Internet, it is preferable to perform the communication via a security apparatus. On the other hand, when communicating with a device associated with the communication system, security services can be implemented in that device. Therefore, depending on the communication destination, it may be possible to switch whether or not the communication is directed to a security apparatus.

Hereinafter, specific embodiments of the present disclosure will be described with reference to the drawings. Unless otherwise specified, the hardware configuration, module configuration, functional configuration, and the like described in each embodiment are not intended to limit the technical scope of the disclosure to only those.

### (Network Overview)

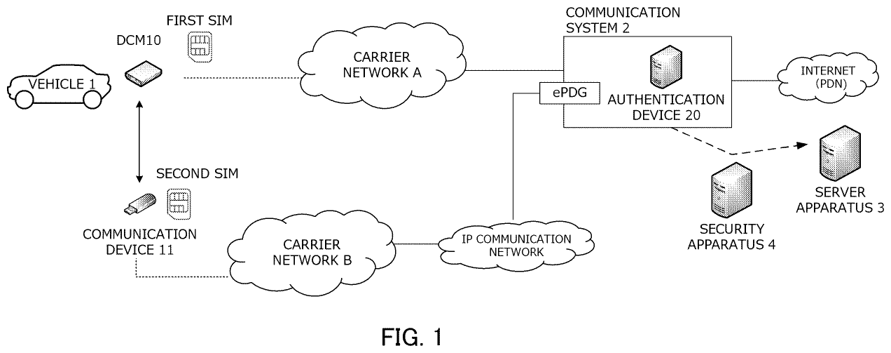

An overview of a vehicle communication network according to an embodiment will be described with reference to FIG. 1. The vehicle communication network according to this embodiment includes a DCM 10 mounted on a vehicle 1, a communication device 11 connected to the DCM 10, a communication system 2, a server apparatus 3, and a security apparatus 4. The communication system 2 is a network including a plurality of communication devices, including an authentication device 20. The DCM 10 and the communication system 2 are connected via a carrier network A or a carrier network B. The system may include a plurality of vehicles 1, server apparatus 3, and security apparatus 4.

The vehicle 1 is a connected vehicle capable of communicating with an arbitrary server apparatus via wireless communication. The vehicle 1 can provide various services by communicating with an external server apparatus (for example, the server apparatus 3) via the DCM 10, which is a wireless communication device. Examples of the various services include a navigation service, a remote control service (e.g, remote air conditioning), an in-vehicle Wi-Fi (registered trademark) service, and an emergency call service. In addition to the devices shown in the figure, the vehicle 1 may also have an on-board terminal that provides these services.

The DCM 10 is a device that performs wireless communication with a predetermined network in order to connect components (e.g, an in-vehicle terminal) of the vehicle 1 to the server apparatus 3. In this embodiment, the DCM 10 is configured to be connectable to a predetermined cellular communication network. The DCM 10 is configured to include an embedded universal integrated circuit card (eUICC) for identifying a user. The eUICC may be a physical SIM card or an eSIM, etc. Hereinafter, the eUICC possessed by the DCM 10 will be referred to as a first SIM.

In the illustrated example, the DCM 10 is configured to be capable of communicating with a carrier network A that constitutes a cellular communication network. Carrier network A includes base stations of a cellular communication network, control devices that manage mobile communication terminals, and the like.

In this embodiment, the carrier network A is connected to the communication system 2. The communication system 2 is a network that connects the carrier network A and a PDN (Packet Data Network) such as the Internet.

While the carrier network A is a network operated by a telecommunications carrier, the communication system 2 can be a system operated by the manufacturer of the vehicle 1 or the like. By connecting these to each other, for example, it becomes possible for the communication system 2 to provide services unique to the vehicle 1.

In this embodiment, the carrier network A provides only a communication line, and the communication system 2 authenticates the DCM 10 and provides services to the DCM 10. The DCM 10 has a first SIM in which profile information for authentication by the communication system 2 is stored. The first SIM is issued by a business operator that operates the communication system 2 (for example, a vehicle manufacturer). The communication system 2 includes an authentication device 20 for authenticating the DCM 10.

The DCM 10 connects to the communication system 2 via the carrier network A, and receives authentication from the communication system 2 using the profile information stored in the first SIM. In this embodiment, the authentication device 20 of the communication system 2 authenticates the DCM 10 based on the profile information held by the first SIM. The authenticated DCM 10 is enabled to communicate with the PDN (for example, the Internet) and can start communication with the server apparatus 3.

In addition, as shown in the figure, in a configuration in which the DCM 10 is directly connected to a cellular communication network (carrier network A), if a communication failure occurs in carrier network A, communication will be interrupted.

To address this issue, a technique has been proposed in which multiple pieces of profile information are stored in a SIM and the network is switched depending on the situation (for example, connecting to a different carrier network).

However, even if such a configuration is adopted, it is not possible to cope with the generational change in cellular communication standards. For example, it is expected that services for older communication standards such as 3G will be discontinued one after another in the future. On the other hand, since automobiles are generally used for long periods of time, such as 10 years or more, it is expected that communication devices such as DCMs that are installed at the time of manufacture will become unusable in the future. In order to change the carrier network, it is necessary to replace the SIM card or communication module, which entails a huge cost.

To address this issue, in this embodiment, the DCM 10 is configured to allow external connection of other communication devices, and in the event that the carrier network A becomes unavailable, an alternative communication path is secured via the other communication device.

As shown in FIG. 1, the DCM 10 is configured to be capable of connecting to an external communication device 11. For example, the DCM 10 is configured to be connectable to a communication device 11 via an interface such as a USB, and to be able to transmit and receive data via the communication device 11. In other words, the DCM 10 is configured to enable USB tethering. The communication device 11 is a device capable of performing wireless communication according to any communication standard. For example, even if the service of the communication standard used by the DCM 10 is terminated, the DCM 10 can continue communication via the communication device 11.

The communication device 11 is a device having a communication function similar to that of the DCM 10. The communication device 11 has a second SIM and can connect to the carrier network B based on profile information stored in the second SIM.

Carrier network B is a cellular communication network independent of carrier network A and communication system 2. For example, the user of the vehicle 1 selects the carrier network B, makes a contract, and prepares the communication device 11 corresponding to the contract.

Since carrier network B is a network independent of communication system 2, carrier network B and communication system 2 cannot be connected to each other as they are. Therefore, in this embodiment, the DCM 10 connected to the carrier network B establishes an IPsec tunnel with the ePDG of the communication system 2, thereby connecting to the communication system 2 via the carrier network B and the IP communication network beyond it.

The communication system 2 has a gateway (enhanced Packet Data Gateway, hereinafter referred to as ePDG) for accommodating access from an IP communication network. The ePDG is a gateway for accommodating untrusted non-3GPP (registered trademark) wireless access. This allows the communication system 2 to receive access via the IP communication network (via carrier network B) in addition to access via the wireless access network (carrier network A). The IP communication network is typically the Internet, but may be something else.

This allows the DCM 10 connected to the carrier network B to communicate with the communication system 2 via a route via an IP communication network (the Internet).

According to this configuration, the user of the vehicle 1 can continue communication between the DCM 10 and the communication system 2 via any route even when the carrier network A is unavailable.

### (Authentication Process Overview)

When the DCM 10 is connected to the communication system 2 via the carrier network A, the communication system 2 can verify the authenticity of the DCM 10 by the SIM (first SIM) issued by the communication system 2 itself. On the other hand, a case where the DCM 10 is connected to the communication system 2 via the carrier network B will be considered. Since the carrier network B and the communication system 2 are independent of each other, the communication system 2 cannot trust the DCM 10 as it is. This is because only authentication by carrier network B (authentication using the second SIM) has been performed on the DCM 10.

Therefore, in this embodiment, the communication system 2 (authentication device 20) authenticates the DCM 10 connected via the ePGD using the authentication information held by the first SIM, in the same way as when the DCM 10 is connected via the carrier network A.

As a result, even if the communication path between the DCM 10 and the communication system 2 is changed, the communication system 2 can continue to perform authentication with the same robustness as cellular communication without changing the device configuration.

Here, a problem that arises when connecting the DCM 10 and the communication system 2 via an IP communication network will be described. Generally, IP communication networks such as the Internet are not secure networks. For example, when the DCM 10 is connected to the communication system 2 via a carrier network A, a security service can be provided within the carrier network A. However, when the DCM 10 connects to the communication system 2 via the ePDG, there are cases where communication may be tampered with on the path, or harmful data (such as a computer virus) may be mixed in.

However, from the standpoint of cost, it is not realistic to execute security services in the DCM 10, which has hardware limitations. Therefore, in this embodiment, communication from the DCM 10 is relayed to a predetermined security apparatus 4 on the condition that “the DCM 10 is connected to the communication system 2 via the ePDG and is authenticated by the first SIM.” The security apparatus 4 is a device disposed on the path between the communication system 2 and the server apparatus 3.

According to this configuration, it becomes possible to direct communication from the DCM 10 connected via an insecure path to a device that provides security services, thereby enabling the DCM 10 to perform secure communication.

### (Network Configuration Details)

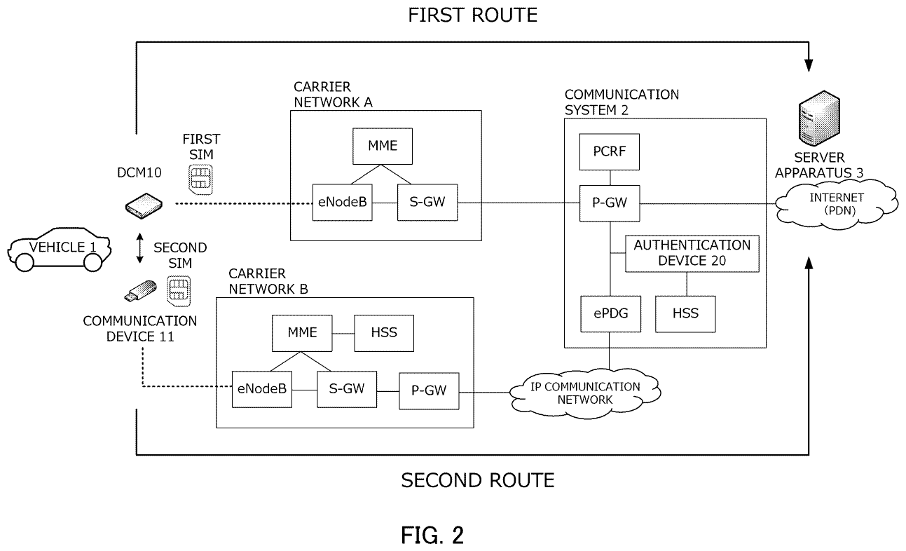

FIG. 2 is a detailed diagram showing the components of each network described with reference to FIG. 1. In addition, in FIG. 2, components related to the first embodiment are extracted from the components of each system and shown, and the components of each system are not limited to those shown in FIG. 2.

Carrier network A is composed of a cellular communication base station (hereinafter, eNodeB), a control device (Mobile Management Entity, hereinafter, MME) that manages mobile communication terminals including DCM 10, and a gateway (Serving Gateway, hereinafter, S-GW) that relays data.

The communication system 2 includes a gateway (Packet Gateway, hereinafter referred to as P-GW) for connecting the EPC to the Internet, and a device for performing network policy and charging management (hereinafter referred to as PCRF).

As described above, the communication system 2 includes a gateway (ePDG) that accommodates access from an IP communication network, and an authentication device 20.

The authentication device 20 is also called an AAA (Authentication Authorization and Accounting) server, and executes a process for authenticating mobile communication terminals such as the DCM 10. The authentication device 20 has a function of performing authentication on behalf of an MME in a normal EPC. The authentication device 20 is connected to a database (Home Subscriber Server, hereinafter referred to as HSS) that manages subscriber information, and performs authentication of the mobile communication terminal based on information (authentication information corresponding to the first SIM) stored in the database.

Carrier network B has a function of authenticating a mobile communication terminal (communication device 11) connected via a base station (eNodeB). Furthermore, carrier network B has a P-GW connected to an IP communication network (e.g, the Internet). This allows the mobile communication terminal (communication device 11) connected to carrier network B to communicate with the IP communication network.

In the case where the DCM 10 establishes a connection using its own wireless communication module, the DCM 10 transmits a connection request to the communication system 2 via the carrier network A. At this time, the DCM 10 is authenticated by the authentication device 20 using authentication information included in the profile information (hereinafter referred to as the first profile) stored in the first SIM.

Furthermore, in the case of establishing a connection via the communication device 11, the DCM 10 transmits a connection request to the communication system 2, with the ePDG of the communication system 2 as the destination. As described above, the ePDG is a gateway that accommodates access from an IP communication network, so that the DCM 10 can communicate with the communication system 2 via the ePDG. At this time, the DCM 10 is authenticated by the authentication device 20 using authentication information included in the profile information (first profile) stored in the first SIM. That is, the DCM 10 is configured to be authenticated by the authentication device 20 using the same authentication information (authentication information included in the first profile) regardless of the path to the communication system 2.

The connection request is processed by the authentication device 20 of the communication system 2, and authentication is performed between the DCM 10 and the authentication device 20. The authentication device 20 authenticates the DCM 10 based on the authentication information included in the first profile. When the authentication is completed, a path from the DCM 10 to the PDN is established, and the DCM 10 and the server apparatus 3 become able to communicate with each other.

In this embodiment, the DCM 10 receives authentication from the authentication device 20 using the same authentication information (profile information) on a route (first route shown in FIG. 2) for directly connecting to the communication system 2 via a cellular communication network and a route (second route) for connecting to the communication system 2 via an IP communication network using tethering. According to this configuration, it becomes possible to provide an additional route (second route) via an IP communication network by utilizing facilities for performing authentication in a cellular communication network, such as the first SIM and the authentication device 20.

Furthermore, when the authentication device 20 “authenticates the DCM 10 connected via the ePDG”, the authentication device 20 relays communication from the DCM 10 to the security apparatus 4. The fact that the DCM 10 is connected via the ePDG means that it is connected via an insecure network. In such a case, the authentication device 20 relays the communication from the DCM 10 to a pre-designated security apparatus 4.

Although the security apparatus 4 is shown as one device in the figure, the security apparatus 4 may be a plurality of devices providing a plurality of security services. In this case, the authentication device 20 may determine, for each connected DCM 10, to which security apparatus the communication should be relayed. Specific examples will be described later.

### (Device Configuration)

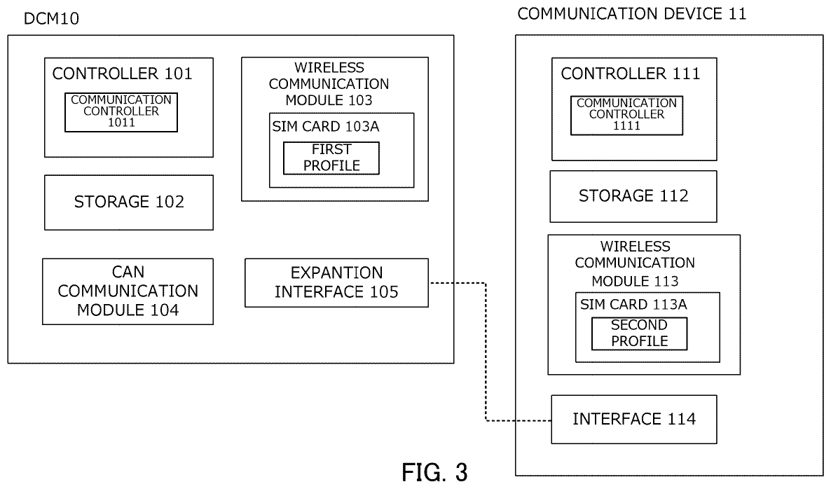

Next, the configuration of each device included in the system will be described. FIG. 3 is a diagram illustrating an example of the configuration of the DCM 10 and the communication device 11 according to the present embodiment.

The DCM 10 can be configured as a computer having a processor (CPU, GPU, etc.), a main memory device (RAM, ROM, etc.), and an auxiliary memory device (EPROM, hard disk drive, removable media, etc.). The auxiliary storage device stores an operating system (OS), various programs, various tables, etc., and by executing the programs stored therein, it is possible to realize various functions (software modules) that correspond to specific purposes, as described below. However, some or all of the functions may be realized as a hardware module using hardware circuits such as ASICs and FPGAs.

The DCM 10 is configured to include a controller 101, a storage 102, a wireless communication module 103, a CAN communication module 104, and an expansion interface 105.

The controller 101 is a computing unit that realizes various functions of the DCM 10 by executing a predetermined program. The controller 101 can be realized by, for example, a hardware processor such as a CPU. Furthermore, the controller 101 may be configured to include a RAM, a ROM (Read Only Memory), a cache memory, and the like.

In this embodiment, the controller 101 of the DCM 10 is configured to have a communication controller 1011 as a software module. The software modules may be realized by executing a program stored in the storage 102 by the controller 101 (CPU). The information processing executed by the software module is synonymous with the information processing executed by the controller 101 (CPU).

The communication controller 1011 establishes a network connection in response to a request from a vehicle component of the vehicle 1. The communication controller 1011 may be configured to be able to select a network to be used for connection. For example, when a first SIM is inserted in the DCM 10, the DCM 10 can establish a network connection via a carrier network A. Furthermore, when a communication device 11 having a second SIM is connected to the DCM 10, the DCM 10 can establish a network connection via a carrier network B. If multiple networks are available, the communication controller 1011 may determine the network to use for the connection based on a user selection.

When the communication controller 1011 connects to a network via the carrier network A, the communication controller 1011 receives authentication from the authentication device 20 using the profile information (first profile) stored in the first SIM.

When a network connection is made via carrier network B, the communication controller 1011 first executes a process of requesting the communication device 11 to connect to carrier network B. Secondly, after the communication device 11 is connected to the carrier network B, the communication device 11 interacts with the communication system 2 (authentication device 20) via the carrier network B and executes a process of being authenticated by the authentication device 20.

The storage 102 is a unit for storing information, and is configured with a storage medium such as a RAM, a magnetic disk, or a flash memory. The storage 102 stores the programs executed by the controller 101, data used by the programs, and the like.

The wireless communication module 103 is a communication device that performs wireless communication with a predetermined network. In this embodiment, the wireless communication module 103 is configured to be able to communicate with a predetermined cellular communication network (carrier network A).

The wireless communication module 103 includes a SIM card 103A. SIM card 103A is the first SIM in FIG. 1. The SIM card 103A is configured as a microcomputer equipped with a CPU and a storage device. The SIM card 103A has information for connecting to the carrier network A (PLMN information) and authentication information for receiving authentication from the communication system 2.

Moreover, the SIM card 103A (first SIM) is configured to store a first profile which is SIM profile information. The first profile is a profile issued by the operator that manages the communication system 2. The first profile includes, for example, identification information such as an International Mobile Subscription Identity (IMSI) or an Integrated Circuit Card ID (ICCID), and authentication information (key information) for undergoing SIM authentication such as AKA authentication.

The CAN communication module 104 is a communication interface for connecting the DCM 10 to an in-vehicle network of the vehicle 1. The CAN communication module 104 may be configured to include, for example, a network interface board that communicates according to a CAN (Controller Area Network) protocol. The DCM 10 can perform data communication with other components (e.g., an in-vehicle terminal, etc.) of the vehicle 1 via the CAN communication module 104.

The expansion interface 105 is an interface for connecting the DCM 10 and the communication device 11 to each other. The expansion interface 105 is, for example, a USB interface. The DCM 10 is configured to be connectable to a communication device 11 via, for example, a USB interface.

Next, the configuration of the communication device 11 will be described.

The communication device 11 is configured to include a controller 111, a storage 112, a wireless communication module 113, and an interface 114.

Similar to the controller 101, the controller 111 is a calculation unit that realizes various functions of the communication device 11 by executing a predetermined program. The controller 111 can be realized by, for example, a hardware processor such as a CPU.

In this embodiment, the controller 111 of the communication device 11 is configured to have a communication controller 1111 as a software module. The software modules may be realized by executing a program stored in the storage 112 by the controller 111 (CPU). The information processing executed by the software module is synonymous with the information processing executed by the controller 111 (CPU).

The communication controller 1111 establishes a network connection in response to a request from the DCM 10. When there is a connection request from the DCM 10, the communication controller 1111 performs network connection via the carrier network B. At this time, the communication controller 1111 receives authentication from the control device (MME) of the carrier network B using the profile information (second profile) stored in the second SIM.

The storage 112 is a unit for storing information, and is configured with a storage medium such as a RAM, a magnetic disk, or a flash memory. The storage 112 stores the programs executed by the controller 111, data used by the programs, and the like.

The wireless communication module 113 is a communication device that performs wireless communication with a predetermined network. In this embodiment, the wireless communication module 113 is configured to be able to communicate with a predetermined cellular communication network (carrier network B).

The wireless communication module 113 includes a SIM card 113A. SIM card 113A is the second SIM in FIG. 1. The SIM card 113A is configured as a microcomputer equipped with a CPU and a storage device. The SIM card 113A has information for connecting to the carrier network B (PLMN information) and authentication information for receiving authentication from the network. The second SIM may be a physical SIM card or an eSIM, etc.

Moreover, SIM card 113A (second SIM) is configured to store a second profile which is SIM profile information. The second profile is a profile issued by the telecommunications carrier that manages carrier network B. The second profile, like the first profile, includes identification information such as the IMSI and ICCID, and authentication information (key information) for undergoing SIM authentication.

The interface 114 is an interface for connecting the DCM 10 and the communication device 11 to each other. The communication device 11 is configured to be connectable to the DCM 10 via an interface such as a USB.

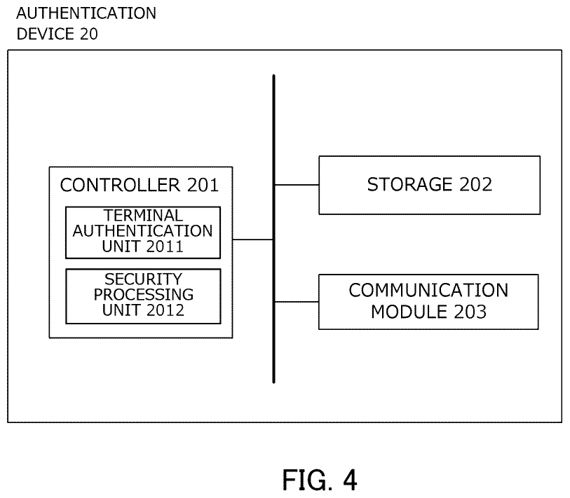

Next, the configuration of the authentication device 20 will be described. FIG. 4 is a diagram showing a schematic example of the configuration of the authentication device 20 according to the present embodiment.

The authentication device 20 is configured as a computer having a controller 201, a storage 202, and a communication module 203.

The authentication device 20 can be configured as a computer having a processor (CPU, GPU, etc.), a main memory device (RAM, ROM, etc.), and an auxiliary memory device (EPROM, hard disk drive, removable media, etc.). However, some or all of the functions (software modules) may be realized as hardware modules using hardware circuits such as ASICs and FPGAs.

The controller 201 is a computing unit that realizes various functions (software modules) of the authentication device 20 by executing a predetermined program. The controller 201 can be realized by, for example, a hardware processor such as a CPU.

In this embodiment, the controller 201 of the authentication device 20 is configured to have two software modules: a terminal authentication unit 2011 and a security processing unit 2012. Each software module may be realized by executing a program stored in the storage 202 by the controller 201 (CPU). The information processing executed by the software module is synonymous with the information processing executed by the controller 201 (CPU).

The terminal authentication unit 2011 receives a request from the DCM 10 and executes a process for authenticating the DCM 10. The authentication process can be performed, for example, according to the following sequence defined by 3GPP.
(1) Processing for Receiving an Attach Request from the DCM 10
(2) A process of sending a request for obtaining authentication-related data (Authentication data Request) to the HSS
(3) Processing for obtaining authentication related data (Authentication data response) from the HSS
(4) Processing for sending a challenge (User Authentication Request) to the DCM 10
(5) Processing for receiving a response (User Authentication Response) from the DCM 10
(6) Processing for confirming the validity of the DCM 10 based on the response In addition, the terminal authentication unit 2011 may also execute processes required for registering the DCM 10 in the communication system 2.

The security processing unit 2012 performs processing for providing security services to the DCM 10 connected to the communication system 2. As described above, when the DCM 10 is connected to the communication system 2 via the ePDG, the communication goes through an unsecure IP communication network, and therefore the security of the communication is not guaranteed. Therefore, the security processing unit 2012 executes a process of relaying the communication from the DCM 10 connected via the ePDG to the security apparatus 4.

An example of the security apparatus 4 is a device that monitors communications to detect or block harmful data.

In addition, when multiple devices are used as the security apparatus 4, data that associates the identifier of the DCM 10 (or the identifier of the first profile) with the identifier of the device to which the data is relayed (hereinafter, security setting data; an example of “binding data” in this disclosure) may be used. This makes it possible to provide different services to each subscriber. For example, it is possible to provide an antivirus service to DCM 10A and a sandbox service to DCM 10B.

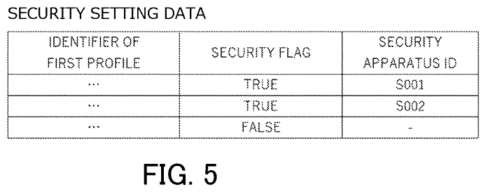

FIG. 5 is an example of the security setting data. In the example of FIG. 5, the identifier of the first profile, the necessity of security service (security flag), and the identifier of the security apparatus to which data is to be transferred (security apparatus ID) are associated with each other. The services to be provided to each DCM may be specified by the user of that DCM (i.e., vehicle 1). For example, when a user subscribes to a communication service, a security service may be specified as an optional contract, and security setting data to be used by the authentication device 20 may be generated based on this. The security setting data may be stored in the authentication device 20 (storage 202) or in an external device that manages the communication contract, and the authentication device 20 may acquire this data.

The storage 202 is a unit for storing information, and is configured with a storage medium such as a RAM, a magnetic disk, or a flash memory. The storage 202 stores the programs executed by the controller 201, data used by the programs, and the like.

The communication module 203 is a communication interface for connecting the authentication device 20 to the communication system 2. The authentication device 20 can perform data communication with other devices disposed in the communication system 2 via the communication module 203.

### (Flowchart)

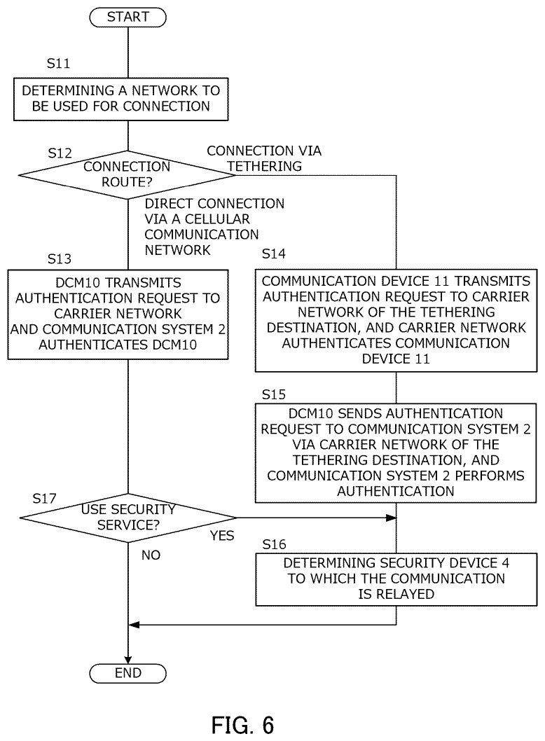

Next, the process executed when the DCM 10 connects to the communication system 2 will be described in detail. FIG. 6 is a flowchart of a process executed when the DCM 10 connects to the communication system 2.

First, in step S11, the communication controller 1011 of the DCM 10 determines a network to be used for connection. For example, when a valid first SIM is inserted in the DCM 10, the communication controller 1011 can determine to establish a connection using the carrier network A shown in FIG. 1. In addition, when a valid first SIM is not inserted into DCM 10 or when a communication device 11 is connected to DCM 10, the communication controller 1011 may decide to establish a network connection via the communication device 11 (carrier network B).

However, if multiple networks are available, the decision as to which network to use may be based on a selection made by the user.

Next, in step S12, the communication controller 1011 determines whether the network to be used for connection is a direct connection via a cellular communication network or a connection via tethering. The direct connection via the cellular communication network refers to a form in which the DCM 10 connects to the communication system 2 via the carrier network A using the built-in wireless communication module 103. The tethering connection is a form in which the communication device 11 connected to the DCM 10 connects to the carrier network B, and the DCM 10 connects to the communication system 2 via the communication device 11 and the IP communication network.

If the network used for the connection is a direct connection via a cellular communication network, the process proceeds to step S13. If the network used for the connection is a tethering connection, the process proceeds to step S14.

In step S13, the communication controller 1011 transmits an authentication request to the carrier network A, and the communication system 2 authenticates the DCM 10.

In this step, the communication controller 1011 transmits an authentication request to the carrier network A via, for example, the base station of the carrier network A. The authentication request may be data for starting an authentication procedure (for example, an attach request defined in 3GPP), or may include substantive data required for authentication. The authentication request reaches the communication system 2 via the carrier network A. For example, the MME of the carrier network A that receives the authentication request may transfer the authentication request to the authentication device 20 included in the communication system 2.

Next, the authentication device 20 included in the communication system 2 starts authentication of the DCM 10 in accordance with the authentication request. For example, the authentication device 20 requests data used for authentication (hereinafter, authentication-related data) from the HSS included in the communication system 2. The authentication device 20 authenticates the DCM 10 using the received authentication related data and information recorded in the first SIM of the DCM 10 (details will be described later).

If the authentication device 20 succeeds in authenticating the DCM 10, the communication system 2 establishes communication paths in the control plane and the user plane. This enables the DCM 10 to communicate with the server apparatus 3 via the P-GW of the communication system 2.

When the process proceeds to step S14, the DCM 10 instructs the communication device 11 to connect to the network. In response to this, the communication device 11 starts a connection using the carrier network B. Specifically, the controller 111 of the communication device 11 transmits an authentication request to the carrier network B via the base station of the carrier network B. The authentication request is received by the MME of carrier network B, and the MME authenticates the communication device 11 based on the authentication related data obtained from the HSS. The authentication utilizes profile information stored in the second SIM.

When the authentication is completed, a communication path is established between the communication device 11 and the carrier network B, which enables the communication device 11 to communicate with the IP communication network via the P-GW.

When the communication device 11 becomes capable of communicating with the IP communication network, authentication is started between the DCM 10 and the communication system 2 in step S15. In step S15, the DCM 10 transmits an authentication request to the communication system 2 via a route via the tethering destination carrier network (i.e., carrier network B). The authentication request reaches the communication system 2 via the IP communication network and the ePDG, and is received by the authentication device 20.

The authentication device 20 then initiates authentication of the DCM 10 according to the received authentication request. The authentication procedure is the same as that described in step S13. That is, in this step as well, authentication of the DCM 10 is performed based on the profile information stored in the first SIM.

If the authentication device 20 succeeds in authenticating the DCM 10, the communication system 2 establishes a communication path. As a result, the DCM 10 connected to the communication system 2 via ePEG becomes capable of communicating with the server apparatus 3 via the P-GW.

When the communication path to the DCM 10 is established in step S15, the process proceeds to step S16.

In step S16, the security processing unit 2012 determines the security apparatus 4 to which the communication from the DCM 10 is relayed. In this step, for example, the security service to be provided to the target DCM 10 may be determined by referring to the security setting data. In the subsequent communications, all data from the DCM 10 is sent to the destination server apparatus 3 via the security apparatus 4. Note that there may be a plurality of security apparatuses 4 that relay communication from the DCM 10.

The process in step S16 may be executed only when the communication is not completed within the communication system 2, such as when the communication destination of the DCM 10 is a device on the Internet. This is because when communication from the DCM 10 is completed within the communication system 2, it may be considered that a certain level of security is ensured.

Returning to step S13, the explanation will be continued.

When the authentication is completed in step S13, the process proceeds to step S17, where it is determined whether or not to use the security service. When the DCM 10 is connected to the communication system 2 via a cellular communication network, the communication path to the communication system 2 can be said to be secure. On the other hand, when the destination of communication from the DCM 10 is a device on the Internet, it may be better to provide security services to the DCM 10 since the communication will pass through an insecure path. In such a case, the process proceeds to step S16. If the security service is not to be used, the process ends.

As described above, the DCM 10 according to this embodiment is configured to be connectable to the communication device 11, and can communicate with the communication system 2 via the communication device 11 and any cellular communication network. Furthermore, the authentication device 20 in the communication system 2 relays communication from the DCM 10 connected via the ePDG to a predetermined security apparatus. This makes it possible to provide security services to the DCM 10 even when the DCM 10 accesses the communication system 2 via an unsecure communication network.

Furthermore, by using the security setting data, it is possible to provide different security services to each subscriber.

### (Modification)

The above-described embodiment is merely an example, and the present disclosure can be modified and implemented as appropriate without departing from the spirit and scope of the present disclosure.

For example, the processes and means described in this disclosure can be freely combined and implemented as long as no technical contradiction occurs.

In addition, in the description of the embodiment, 4G (LTE-Advanced) is used as an example of the standard for the cellular communication network, but 3G, 5G, etc. may also be adopted as the communication standard. In this case, the ePDG can be replaced with an N3IWF (non-3GPP Interworking Function) (in the case of 5G), a PDG (in the case of 3G), etc.

In addition, in the description of the embodiment, the DCM 10 is exemplified as the mobile communication terminal, but the mobile communication terminal may be an IoT terminal or the like.

In addition, in the description of the embodiment, the DCM 10 is capable of connecting to the carrier network A. However, the DCM 10 does not necessarily have to have the wireless communication module 103, and does not necessarily have to have the function of connecting to the carrier network A. In other words, the DCM 10 may be configured to require communication via the communication device 11. Even in this case, the DCM 10 receives authentication from the authentication device 20 using the profile information stored in the first SIM. In such a configuration, the first SIM is not used to connect to the carrier network, but is used only for authentication purposes.

Furthermore, in the description of the embodiment, an example has been given in which the DCM 10 is authenticated using the profile information stored in the SIM, but the DCM 10 may be authenticated by other methods. For example, the DCM 10 may store in the storage 102 a pair of key information and a digital certificate (e.g, issued by a certificate authority) for verifying the authenticity of the key information. The authentication device 20 can also use such information to authenticate the DCM 10. In either case, authentication is performed using the same authentication information regardless of the communication path.

Furthermore, the processes described as being performed by one device may be shared and executed by a plurality of devices. Alternatively, the processes described as being performed by different devices may be performed by a single device. In a computer system, the hardware configuration (server configuration) by which each function is realized can be flexibly changed.

The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network. Non-transitory computer-readable storage media include, for example, any type of disk, such as a magnetic disk (e.g., a floppy disk, a hard disk drive (HDD), etc.), an optical disk (e.g., a CD-ROM, a DVD disk, a Blu-ray disk, etc.), a read-only memory (ROM), a random-access memory (RAM), an EPROM, an EEPROM, a magnetic card, a flash memory, an optical card, or any type of medium suitable for storing electronic instructions.

What is claimed is:

1. An information processing apparatus that is arranged within a communication system that comprises a storage that stores authentication data for authenticating mobile communication terminals and a gateway that accommodates access from a first communication network, and authenticates a mobile communication terminal connected via the first communication network and the gateway, using the authentication data, the information processing apparatus comprising:
a controller that relays communications from the mobile communication terminal to one or more security apparatuses based on information related to the authentication.

2. The information processing apparatus according to claim 1, wherein
the information related to the authentication includes an identifier of the mobile communication terminal.

3. The information processing apparatus of claim 2, wherein
the controller acquires binding data that associates the mobile communication terminal with a security apparatus to which communications from the mobile communication terminal are to be relayed, and determines the security apparatus to which communications from the mobile communication terminal are relayed, based on the binding data.

4. The information processing apparatus of claim 1, wherein
the controller relays communications from the mobile communication terminal to the one or more security apparatuses when destination of communications from the mobile communication terminal is not an apparatus within the communication system.

5. A communication system comprising:
a storage that stores authentication data for authenticating mobile communication terminals,
a gateway that accommodates access from a first communication network, and
a controller configured to perform:
authenticating a mobile communication terminal connected via the first communication network and the gateway, using the authentication data; and
relaying communications from the mobile communication terminal to one or more security apparatuses based on information related to the authentication.
